(19) United States
(12) Patent Application Publication
(10) Pub. No.: US 2016/0080649 A1
(43) Pub. Date: Mar. 17, 2016

(54) SYSTEMS AND METHODS FOR PRODUCING FIRST-PERSON-PERSPECTIVE VIDEO FOOTAGE

(71) Applicants: Marshall Lee Bex, Hillsboro, OR (US); Russell Powell Hirtzel, Portland, OR (US)

(72) Inventors: Marshall Lee Bex, Hillsboro, OR (US); Russell Powell Hirtzel, Portland, OR (US)

(21) Appl. No.: 14/855,215

(22) Filed: Sep. 15, 2015

Related U.S. Application Data
(60) Provisional application No. 62/050,928, filed on Sep. 16, 2014.

(51) Int. Cl. H04N 5/232; G02B 27/01; H04N 7/18

(52) U.S. Cl. CPC H04N 5/23238; H04N 7/181; G02B 27/017

(57) ABSTRACT

A system can include an article configured to be worn on a person's head, multiple camera devices configured to provide video feeds that collectively produce a three-hundred-and-sixty degree video experience from the person's perspective, each camera device being coupled with the article, and a transmitter device communicatively coupled with the cameras and configured to transmit the video feed to an external viewing device.

### CROSS-REFERENCE TO RELATED APPLICATION

This application claims the benefit of U.S. Provisional Patent Application Ser. No. 62/050,928, titled “Integration of lenses through a helmet, hat, or other article to produce 360 degree video” and filed on Sep. 16, 2014, the content of which is fully incorporated by reference herein.

### BACKGROUND

Sports spectatorship in the United States is at an all-time high. Super Bowl XLIX alone drew 112.1 million viewers. From football to soccer to baseball, fans can't get close enough to the action. To satisfy the thirst of sports fans, there is an ever increasing demand for technology to bring people closer to the action on the playing field. Standard video viewing methods keep the audience away from the action.

### SUMMARY

The closest a sports fan can get to the action for virtually any given sport is standing in the shoes of one of the athletes on the field/court/etc.; i.e., to see through the eyes of the athlete freely in all directions. The disclosed technology provides such an opportunity to fans or anyone else interested in experiencing a sporting event from the perspective of one of the participants. However, as described herein, the possible applications for the technology extend far beyond mere entertainment purposes.

### BRIEF DESCRIPTION OF THE DRAWINGS

FIG. 1 shows an embodiment of the system for producing first-person-perspective video footage.

FIG. 2 shows an embodiment of the system for producing first-person-perspective video footage.

FIG. 3 shows an embodiment of the system for producing first-person-perspective video footage.

FIG. 4 shows an embodiment of the system for producing first-person-perspective video footage.

FIG. 5 shows a flow chart of an embodiment of a method for producing first-person-perspective video footage.

FIG. 6 shows a flow chart of an embodiment of a method for producing first-person-perspective video footage.

FIG. 7 shows a flow chart of an embodiment of a method for producing first-person-perspective video footage.

FIG. 8 shows an embodiment of a flow chart of an embodiment of a method for producing first-person-perspective video footage.

FIG. 9 illustrates an embodiment of the method to create a first-person, three-hundred-sixty degree video experience.

### DETAILED DESCRIPTION OF THE EMBODIMENTS

Embodiments of the disclosed technology generally include systems and methods that produce first-person-perspective video footage.

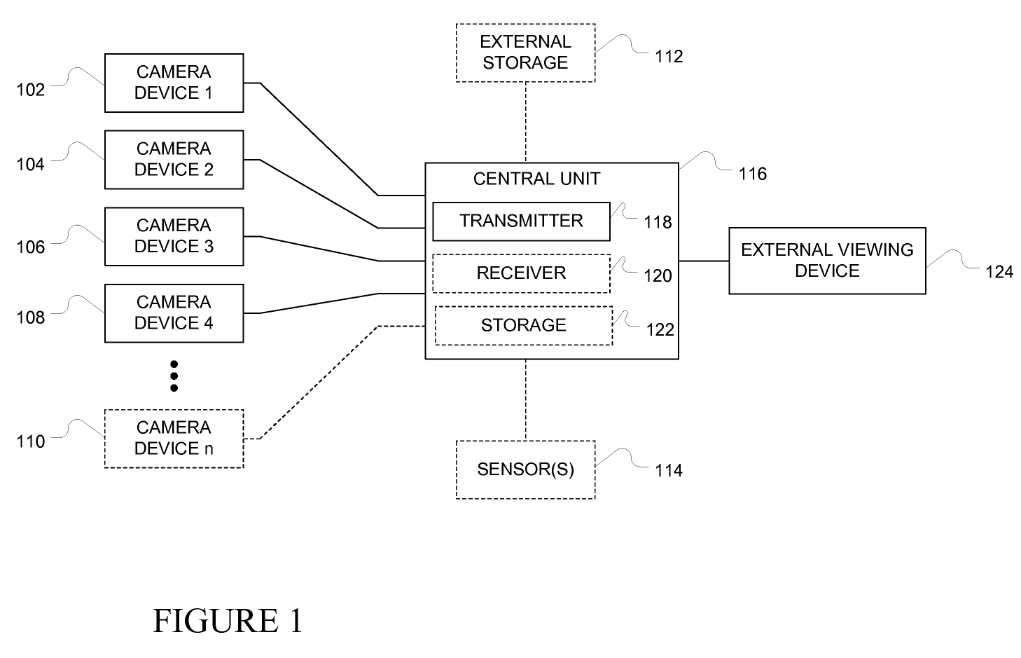

FIG. 1 illustrates an embodiment of a system for producing a first-person-perspective video footage. As will become apparent to one skilled in the art, the disclosed embodiments are merely exemplary in nature, and the systems and methods may be employed in any suitable environment. Within the system to produce first-person, 360 degree video footage, a central unit 116 located within an article is comprised of a transmitter 118, a receiver 120, and a storage element 122. In some embodiments, one or all of said components may be located outside of the central unit 116. The central unit 116, in some embodiments, may not exist or simply refer to a locality of components.

The system further is comprised of a plurality of cameras that are each configured to capture video footage. The number of camera devices may vary among embodiments. The embodiment illustrated in FIG. 1 is comprised of Camera Device 1 (102), Camera Device 2 (104), Camera Device 3 (106), Camera Device 4 (108), up to a number of other cameras illustrated as Camera Device n (110). The one or more camera devices may be permanently or temporarily attached to the article. The camera may be attached to the article to have only one angle to prevent movement during action. In other emodiments, as illustrated in more detail below, some embodiments of the camera devices allow the angle of the camera device to be repositioned to capture the desired video footage.

The embodiment in FIG. 1 may optionally further comprise external storage 112 and/or sensor(s) 114. Many storage devices are available as external storage 112 in the system, such as without limitation internal hard drives, DVDs, CDs, external hard drives, solid state drives, network attached storage drives, thumb drives, flash drives, remote storage options, cloud storage. These storage devices are exemplary in nature. Many storage devices have the necessary characteristics to provide the proper storage to save video footage. The video footage may be transmitted to the external storage 112 wireless or via a wire, such as a USB cord.

The one or more sensors 114 may monitor and/or report various conditions of the system, including without limitation the video capture functions of one or more of the camera devices (102, 104, 106, 108, 110), the functionality/condition of the transmitter 118, the functionality/condition of the receiver 120, the functionality/condition of the storage 122, the angle of one or more of the camera devices (102, 104, 106, 108, 110), and the amount of storage left on the storage 122.

FIG. 1 further illustrates an embodiment of the system with an external viewing device 124. A number of different devices are available for the user to use as the external viewing device 124, such as desktop computer, laptop computer, cell phone, television, tablet, virtual reality googles, projector screen, and other computing devices. Similarly, other portions of this discussion provided to aid in understanding the scope of the embodiments are not intended to, nor should be assumed to, limit the scope to the examples given. For example, the external viewing device 124 discussed here is generally a desktop or portable device having a capability to display the first-person-perspective video footage. The video footage may be transmitted wirelessly or via a hard-wire connection, such as a USB cord, to the external viewing device. In some embodiments, the external viewing device may further be capable of processing the video footage from the plurality of camera to create a first-person, three hundred sixty degree perspective. In other embodiments, there may be an extra step of transmitting the video feed first to a processing device then to the external viewing device for review. In yet further embodiments, the video feed is processed before transmission from the article.

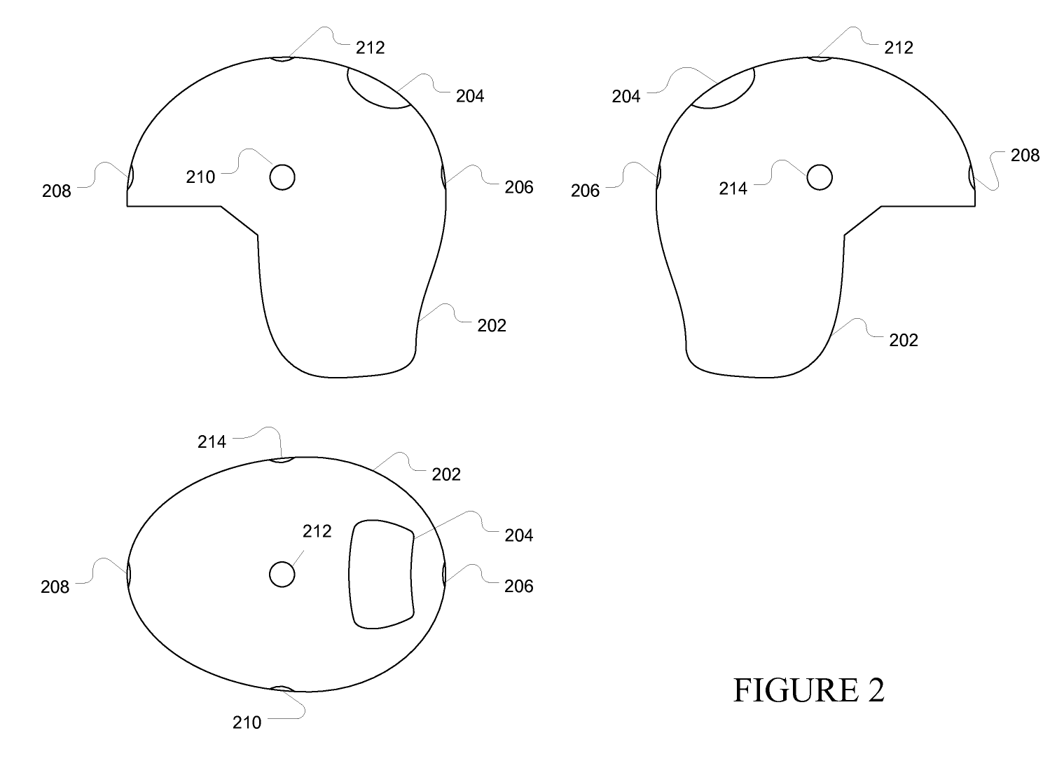

FIG. 2 demonstrates an exemplary embodiment of the implementation of the system to produce a first-person-perspective video footage. The system comprises an article 202, as shown in this embodiment, a helmet, configured to be worn on a person's head. A person may be an athlete, a referee, audience member, a viewer, a journalist, a military member, police member or any person suitable for capturing video footage. As such the disclosed system and methods may be deployed in a number of environments, including without limitation a football field (ex: athlete, referee, broadcaster); a soccer field (ex: athlete, referee, broadcaster), a stage (actor, director, coach, dancer); military battle or training; and police observation and arrests.

A transmitter device 204 is exemplarily positioned at the top and back of the article 202. However, the transmitter device may be positioned in any location on the article 202 for a variety of reasons. Such reasons may include a position optimizes transmission or does not impact the ability of the article to function correctly. For example, certain locations of the transmitter device 204 may impact a helmet's ability to protect the athlete's head.

Further, the system shown in FIG. 2 illustrates a plurality of camera devices (206-214) are positioned/configured around the article to each provide a video feed that collectively may produce a three-hundred-sixty degree video experience from a person's perspective. One or more of said camera devices (206-214) are removable from the article or alternatively permanently integrated into the article.

Additionally, one or more of the camera devices (206-214) may, in some embodiments, be flush with the article as to not alter the contours of the article. In yet other embodiments, the camera devices may alter the shape of the article to facilitate incorporation into the article. For example, it may be necessary to expand the size and shape of a cap to provide for proper integration of the camera devices. It may further be necessary to provide for internal changes to a cap to provide comfort to the wearer, such as an internal cushioning device for the wearer.

In the illustrated embodiment, a camera device 206 is position at the back of the helmet. In this example, the back camera device 206 is able to capture video to the rear of the person up to and including approximately a circular video behind the person. Such video footage may then be used to compose a three hundred sixty degree video experience, which contains a middle-rear view, an upper-rear view, a lower-rear view, a right-rear view, and a left-rear view.

In the example, another camera device 208 is positioned on the front of the helmet and captures video footage in front of the person. This camera device 208 may also capture up to and including approximately a circular video in front of the person. Such video footage may then be used to compose a three hundred sixty degree video experience, which contains a middle-front view, an upper-front view, a lower-front view, a right-front view, and left-front view. One skilled in the art will recognize that the configuration of the system is not fixed, but can be arranged in configurations to fit the article or to meet the needs of the specific three-hundred-sixty degree scene to be captured.

In other embodiments, the system may further be comprised of various other components to assist the system to function properly. Such components include but are not limited to: circuity for the various aspects of making the components work and work together as well as batteries for powering the various parts of the system.

The embodiment shown in FIG. 2 further illustrates camera device 210 and camera device 214 positioned on the right and left of the article respectively. As with the front and rear cameras 208 and 206, both cameras 210 and 214 may capture approximately a circular video to each side of the person. The right camera device 210 captures video footage comprised of a middle-right view, an upper-right view, a lower-right view, a front-right view, and a rear-right view. The left camera device 214 captures video footage comprised of a middle-left view, an upper-left view, a lower-left view, a front-left view, and a rear-left view. Each set of video footage may then be used to produce a three hundred sixty degree video footage. A final camera device 212 in this embodiment is shown on the top of the article. Such video footage may then be used to create the video experience of looking up in the first-person-perspective, such as an athlete wearing the article, watching and catching a football thrown from a long distance.

It would be understood to one skilled in the art that the camera devices may capture as much or as little of the environment as desired, depending on equipment and adjustment made to said equipment. Such adjustments may be accomplished automatically or manually.

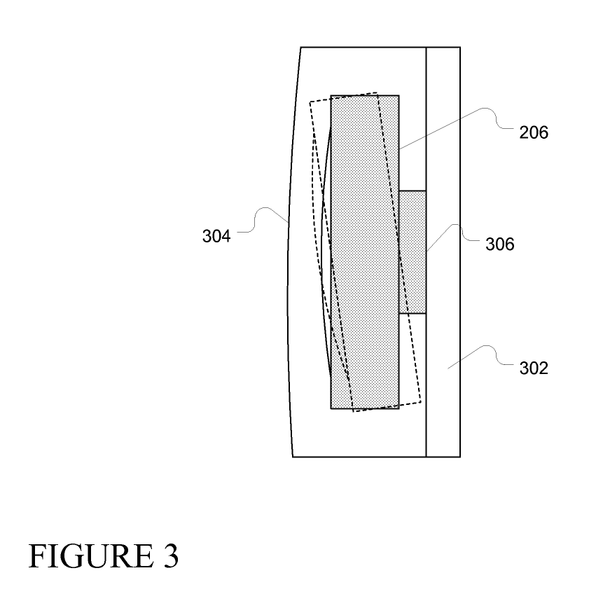

FIG. 3 demonstrates an exemplary embodiment of a close perspective of a camera device 206. The size, shape and configuration of the camera device 206 are exemplary in nature and not limiting. In this embodiment, the camera device 206 may be attached using an attachment device 306 to any suitable surface 302 located within the article. Said attachment may be accomplished using any suitable attachment device 306, including without limitation adhesives, mounting devices, screws, or integration into the article. Further, in the embodiment shown in FIG. 3, the camera device is protected by a bather 304, such as a lens window composed of any suitable substance, which is transparent and provides the desired protection. Such substances include but are not limited to shatter-proof glass or acrylic. The barrier may further be prepared to augment or enhance the vision of the lens, depending on the desired effect.

FIG. 3 further illustrates an embodiment which permits the camera device 206 to be configured at a number of different angles. The range of possible angles may vary greatly from −90 degrees to +90 degrees, for example. The dashed lines in FIG. 3 are merely exemplary in nature and demonstrate the ability of the camera device 206 to be positioned at different angles. Such angles of the camera device 206 may be adjusted manually or automatically. However, one skilled in the art would understand that the camera device 206 may also be configured to only allow one angle. In other embodiments, the camera device may have the ability to switch to and from embodiments that allow reconfiguration of angles to not only having one angle.

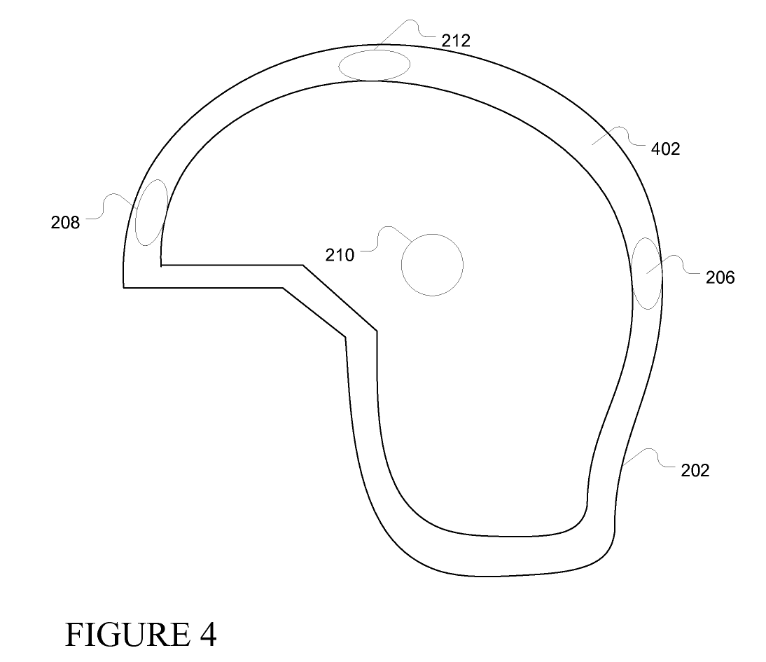

FIG. 4 demonstrates one embodiment of the system for producing first-person-perspective video footage. The article 202 shown in FIG. 4 is a helmet configured to be worn on a football player's head. In this embodiment, the camera devices (206-212) are permanently integrated into the helmet and located within the lining of a cushion layer 402. Such a configuration allows protection of the football player from the components of the camera devices (206-212) and various other parts of the system. Thus, the helmet still provides adequate protection for the football player while capturing video footage.

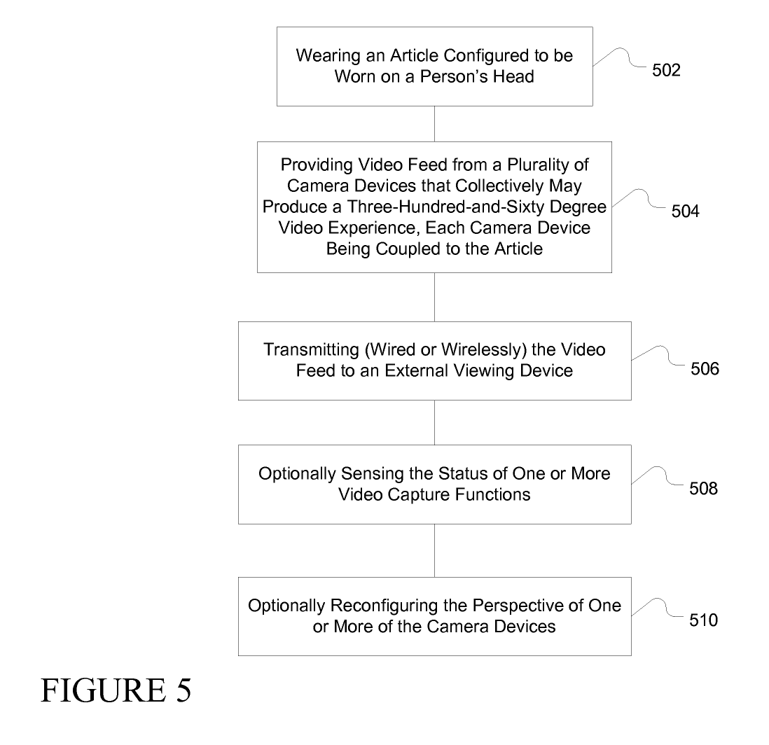

FIG. 5 demonstrates an exemplary embodiment of a method for capturing three hundred sixty degree, first-person-perspective video footage. In the shown embodiment, the method is comprised of the following steps: wearing an article configured to be worn on a person's head (502); providing video feed from a plurality of camera devices that collectively may produce a three-hundred-and-sixty degree video experience, each camera device being coupled to the article (504); and transmitting (wired or wirelessly) the video feed to an external viewing device (506). Optionally, the method may further comprise sensing the status of one or more of video capture functions (508) and/or reconfiguring the perspective/angle of one or more of the camera devices (510).

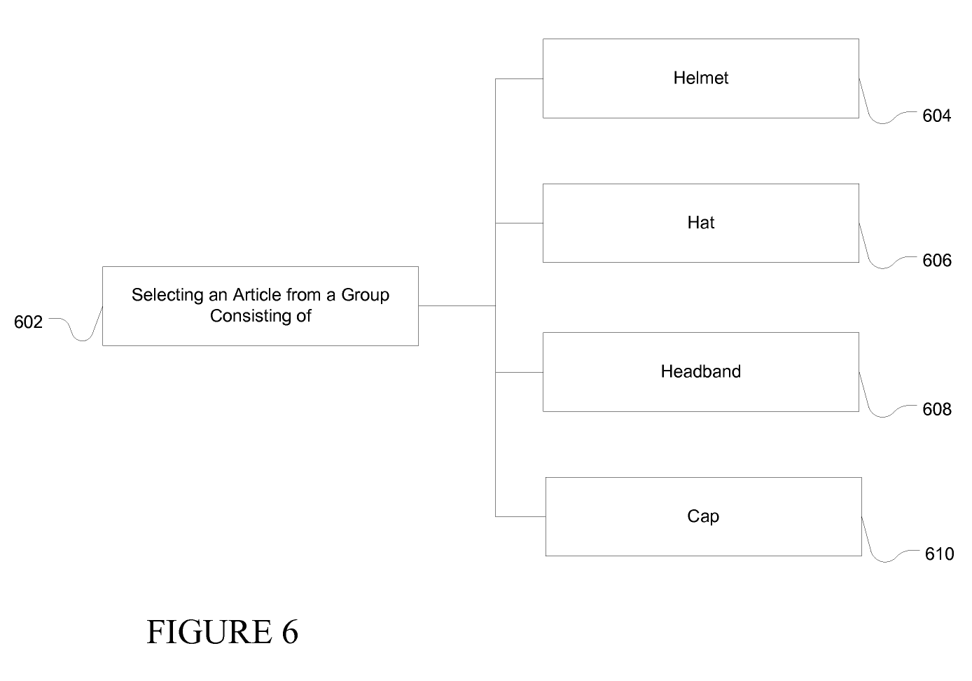

FIG. 6 illustrates an exemplary embodiment of the method for selecting an article to capture video footage to produce a first-person-perspective video experience. An article may be selected from a group consisting of helmet, hat, headband, and a cap. Said selection of an article will be suited to the particular environment and conditions of capturing the video footage. For example, in one embodiment, the hat is selected as the article by a referee for purposes of capturing video footage of the referee's perspective of the football field. Said video footage may then be used for purposes of playback reviews.

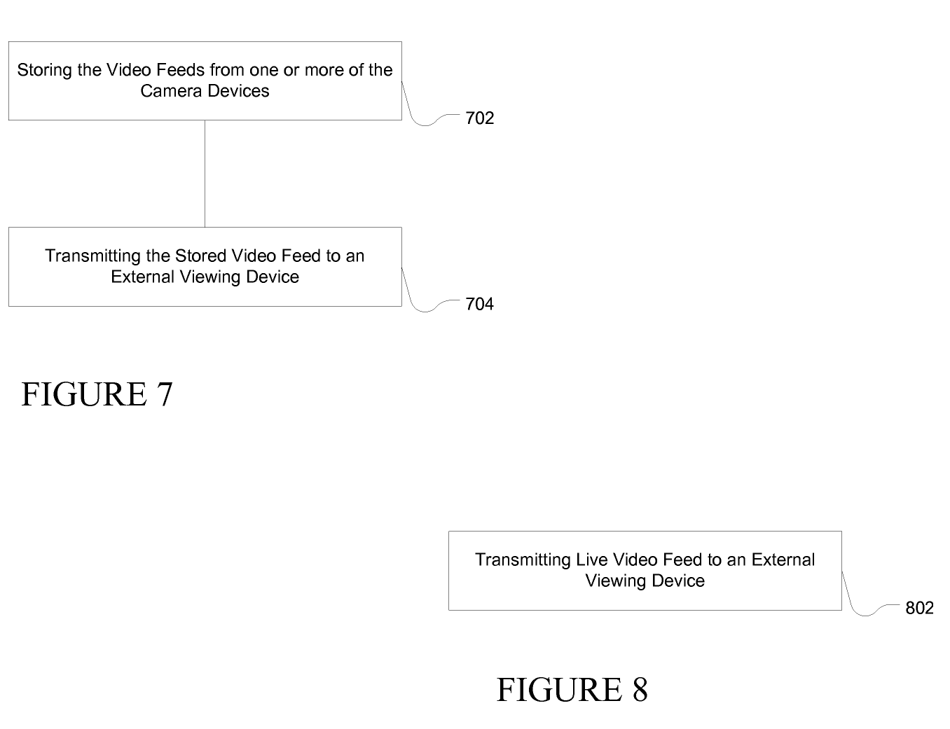

FIGS. 7 and 8 illustrate exemplary embodiments of the method for transmission of the video footage captured by one or more of the camera devices. In FIG. 7, the method includes storing the video feed from one or more of the video camera devices 702 and, at 704, transmitting the stored video feed to an external viewing device. Such transmission may be accomplished wirelessly or via a wired connection, such as a USB cord. The timing of the transmission may vary from instantaneous to a very long period of time, such as days, weeks, months, or even years. As an example, the video feed may be stored during a training session for an athlete for purposes of reviewing his or her performance. Once the training session is finished, the coach may use wire transmission to an external viewing device to review the footage for coaching purposes. In other embodiments, at 802, a live action video feed may be transmitted to an external viewing device. For example, the transmission may be accomplished wirelessly and provide live action review of the video footage, such as during a football game for the referees and fans.

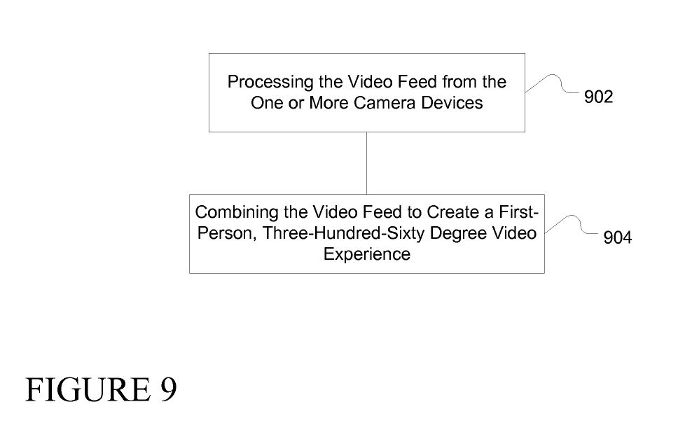

FIG. 9 illustrates an embodiment of the method to create a first-person, three-hundred-sixty degree video experience. At 902, the video feed from the one or more camera devices is processed/prepared for combining the video feed. For example, one reviewing the video footage may find that he or she may only want to combine a short portion of the video feeds to create the desired video experience. In other embodiments, this processing step may be automatically accomplished, such as software that eliminates unusable video footage. At 904, the video feed is combined to create a first-person, three-hundred-sixty degree video experience. One skilled in the art will appreciate that the processing and combining steps may be accomplished in one step rather than two separate steps. Alternatively, the video footage may not need to be processed prior to combining, thus eliminating the processing step entirely. For example, the entire video footage may be desired to create the first-person, three-hundred-sixty degree video experience. In this case, processing would not be necessary.

In other embodiments, the video footage from one or more of the camera devices may be used individually without combining the footage to produce the three-hundred-sixty degree experience. In this case, a user may use the video footage from the one or more camera devices to create still images, panoramas, and/or non-360-degree video. Such products would be useful, for example, in publications, branding, commercial marketing, broadcast, internet, educational, and training.

Once the video footage is combined, a user reviewing the first-person, three-hundred-sixty degree video experience will be able to look in all directions. For example, the user will be able to look up, down, right, left, behind, and to the front as desired. As such, the user will feel as he or she is in the action. For example, the video experience may be used by a broadcasting network to put a fan on the football field for purposes of entertainment. In some embodiments, the video experience will be of a two-dimensional view or a three-dimensional view.

Having described and illustrated the principles of the invention with reference to illustrated embodiments, it will be recognized that the illustrated embodiments may be modified in arrangement and detail without departing from such principles, and may be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

1. A system for producing first-person-perspective video footage, comprising:
an article configured to be worn on a person's head;
a plurality of camera devices configured to each provide a video feed that collectively produce a three-hundred-and-sixty degree video experience from the person's perspective, each camera device being coupled with the article; and
a transmitter device communicatively coupled with the plurality of cameras and configured to transmit the video feed to an external viewing device.

2. The system of claim 1 wherein the article is selected from a group consisting of a helmet, a hat, a headband and a cap.

3. The system of claim 1 wherein the system is configured to transmit live action video feed.

4. The system of claim 1 wherein the system is configured to store the video feeds from one or more of the camera devices.

5. The system of claim 1, further comprising a protective barrier for each of the plurality of cameras.

6. The system of claim 5 wherein the protective barrier includes a lens window.

7. The system of claim 1 wherein the transmitter device includes a wired transmission device.

8. The system of claim 1 wherein the transmitter device includes a wireless transmission device.

9. The system of claim 1, further comprising one or more of the following: a sensor, a receiver, circuitry, a battery, a connection port, storage media, or a status indicator.

10. The system of claim 1, further comprising mounting devices.

11. The system of claim 1, further comprising safety gear.

12. The system of claim 1, further comprising a lens configured with each of the plurality of cameras.

13. A method for acquiring first person perspective video footage, comprising:
wearing an article configured to be worn on a person's head;
providing video feed from a plurality of camera devices that collectively may produce a three-hundred-and-sixty degree video experience from the person's perspective, each camera device being coupled to the article; and
transmitting the video feed to an external viewing device.

14. The method of claim 13 wherein the article is selected from a group consisting of a helmet, a hat, a headband, and a cap.

15. The method of claim 13 wherein the system is configured to transmit live action video feed.

16. The method of claim 13, wherein the system is configured to store the video feeds from one or more of the camera devices.

17. The method of claim 16, further comprising transmitting the video feed stored from the one or more of the camera devices.

18. The method of claim 13, wherein the transmitting the video feed to the device is completed via a wire.

19. The method of claim 13 wherein the transmitting the video feed to the device is wireless.

20. The method of claim 13, further comprising sensing the status of one or more video capture functions.

21. The method of claim 13, further comprising reconfiguring the perspective of one or more of the camera devices.
